(19) United States
(12) Patent Application Publication
(10) Pub. No.: US 2026/0257873 A1
(43) Pub. Date: Sep. 3, 2026

(54) PICKING DEVICE

(71) Applicant: Murata Machinery, Ltd., Kyoto-shi, Kyoto (JP)

(72) Inventors: Kazuya IWASAKI, Inuyama-shi (JP); Masataka HAYASHI, Inuyama-shi (JP); Haruki OGO, Inuyama-shi (JP)

(21) Appl. No.: 18/863,722

(22) PCT Filed: May 16, 2023
(86) PCT No.: PCT/JP2023/018195

§ 371 Date: Nov. 7, 2024

(30) Foreign Application Priority Data
May 24, 2022 (JP) 2022-084245

(51) Int. Cl. B65G 47/90; B25J 5/04; B25J 9/00; B25J 15/06

(52) U.S. Cl. CPC B65G 47/907; B25J 5/04; B25J 9/0084; B25J 15/0616

(57) ABSTRACT

A picking device includes a rail and a first transfer device and a second transfer device to transport objects. The first transfer device includes a first traveling body guided by the rail a first arm attached to the first traveling body, and a first holder attached to the first arm, and the second transfer device includes a second traveling body guided by the rail, a second arm attached to the second traveling body, and a second holder attached to the second arm.

### BACKGROUND OF THE INVENTION

### 1. Field of the Invention

The present invention relates to picking devices to pick up and transport an object and release the object in a predetermined place.

### 2. Description of the Related Art

In a distribution center or the like, a so-called picking operation in which a plurality of types of products corresponding to retail stores, individuals, and the like are sorted into cardboard boxes is an operation that has a great influence on efficiency in distribution. Although the picking operation has been conventionally performed by a human, the picking operation is recently attempted to be performed by a picking robot.

For example, Japanese Unexamined Patent Application Publication No. 2020-037144 discloses a picking device in which two picking robots are arranged side by side. Thus, efficiency of the picking operation performed by the picking robots is intended to be improved.

### SUMMARY OF THE INVENTION

However, when an articulated robot as described in Japanese Unexamined Patent Application Publication No. 2020-037144 is used for the picking operation, there is a problem that a distance between a transfer source and a transfer destination is limited since an object can be transferred only within a range that can be reached by arms of the picking robots. Moreover, since a plurality of articulated robots are arranged close to each other, there is another problem that control for preventing mutual interference between the picking robots becomes complicated and thus, efficiency of the picking operation is reduced.

Example embodiments of the present invention provide picking devices that each operate even when a distance between a transfer source and a transfer destination is long and can prevent reduction in picking efficiency.

A picking device according to an example embodiment of the present invention includes a rail that extends over a first area and a second area in a horizontal direction, a first transfer device to transport an object from the first area to the second area by picking up the object in the first area, traveling along the rail, and then releasing the object in the second area, the first transfer device including a first traveling body that travels while being guided by the rail, a first arm that includes a proximal end portion attached to the first traveling body, and a first holder that is attached to a distal end portion of the first arm to hold an object by suction, and a second transfer device to transport an object from the first area to the second area by picking up the object in the first area, traveling along the rail, and then releasing the object in the second area, the second transfer device including a second traveling body that travels while being guided by the rail, a second arm that includes a proximal end portion attached to the second traveling body, and a second holder that is attached to a distal end portion of the second arm to hold an object by suction, wherein the first arm further includes a first upper arm that includes a proximal end portion attached to the first traveling body to enable rotation of the first upper arm with respect to the first traveling body in a prescribed plane intersecting an extending direction of the rail and prevent motion of the first upper arm relative to the extending direction, and a first forearm that includes a proximal end portion attached to a distal end portion of the first upper arm to enable rotation of the first forearm with respect to the first upper arm in a plane parallel to the prescribed plane and prevent motion of the first forearm relative to the extending direction, the first holder is attached to a distal end portion of the first forearm, the second arm further includes a second upper arm that includes a proximal end portion attached to the second traveling body to enable rotation of the second upper arm with respect to the second traveling body in a plane parallel to the prescribed plane and prevent motion of the second upper arm relative to the extending direction, and a second forearm that includes a proximal end portion attached to a distal end portion of the second upper arm to enable rotation of the second forearm with respect to the second upper arm in a plane parallel to the prescribed plane and prevent motion of the second forearm relative to the extending direction, and the second holder is attached to a distal end portion of the second forearm.

According to example embodiments of the present invention, since two transfer devices transfer objects while traveling and being guided by the same rail, it is possible to deal with a change in a distance between a transfer source and a transfer destination by only changing the length of the rail according to the distance between the transfer source and the transfer destination. Moreover, since a plurality of transfer devices are guided by the rail, transfer efficiency is increased as compared to a picking device including only one transfer device.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view illustrating a picking device.

FIG. 2 is a perspective view illustrating a first transfer device and a second transfer device.

FIG. 3 is a side view illustrating a possible posture of the first transfer device based on a structure of the first transfer device.

FIG. 4 is a plan view illustrating an example of an arrangement of a first holder and a second holder.

FIG. 5 is a perspective view illustrating another example of a transfer device.

### DETAILED DESCRIPTION OF THE EXAMPLE EMBODIMENTS

Hereinbelow, example embodiments of picking devices according to example embodiments of the present invention are described with reference to the Drawings. It should be noted that the example embodiments below are merely examples, and therefore is not intended to limit the scope of the present invention. For example, the shapes, structures, materials, elements, relative positional relationships, connection states, numerical values, mathematical expressions, contents of each of steps of methods, processing order of the steps, etc., in the example embodiments below are mere examples and may include content not described below. Moreover, although geometric terms such as parallel, orthogonal, etc., may be used, these terms do not mean mathematical exactness and include a substantially allowable error or deviation. Moreover, terms such as simultaneously, same, etc. include a substantially allowable range.

Furthermore, the Drawings may include exaggerations, omissions, or scale adjustments for the purpose of explaining example embodiments of the present invention, and may be schematic drawings in which the shape, positional relationship, and scale are modified from the actual shape, positional relationship, and scale. Furthermore, the X-axis, Y-axis, and Z-axis in the Drawings indicate Cartesian coordinates arbitrarily set for explaining the Drawings. Namely, the Z-axis is not limited to an axis along a vertical direction, and the X-axis and Y-axis are not necessarily present in a horizontal plane.

Moreover, the following description may comprehensively explain a plurality of inventions as one example embodiment. Furthermore, a portion of the content described below is a description of an arbitrary element or elements related to example embodiments of the present invention.

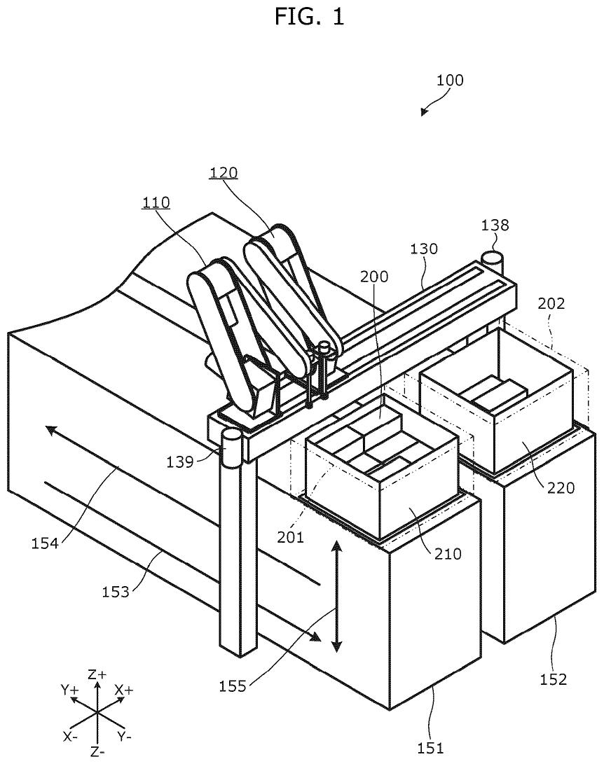

FIG. 1 is a perspective view illustrating picking device 100. Picking device 100 includes rail 130, first transfer device 110 that travels along rail 130 and transfers object 200 from first area 201 to second area 202, and second transfer device 120 that travels along rail 130 and transfers object 200 from first area 201 to second area 202. Picking device 100 includes first transport device 151 and second transport device 152.

First area 201 is an area in which object 200 to be transferred is placed and object 200 placed is picked up by picking device 100. In the present example embodiment, transfer source box 210 in which objects 200 to be picked up are contained is placed in first area 201. Objects 200 that are products of one type are contained in transfer source box 210, and objects 200 that are products of another type are contained in another transfer source box 210. It should be noted that there may be a case where objects 200 that are products of the same type are contained in different transfer source boxes 210, or a case where objects 200 that are products of a plurality of types are contained in a single transfer source box 210. Second area 202 is an area to which object 200 is transferred and an area in which object 200 picked up in first area 201 is released. In the present example embodiment, transfer destination box 220 in which object 200 released is to be contained is placed in second area 202. One or more objects 200 of the same type are transferred from a single transfer source box 210 to transfer destination box 220. Moreover, there may be a case where one or more objects 200 of the same type or different types are transferred from different transfer source boxes 210.

First transport device 151 transports, to first area 201, transfer source box 210 in which objects 200 are contained. Moreover, first transport device 151 transports transfer source box 210 out of first area 201 after at least one of objects 200 contained in transfer source box 210 has been transported out by at least one of first transfer device 110 or second transfer device 120. The type of first transport device 151 is not particularly limited and is exemplified by, for example, a conveyor, an unmanned transport vehicle, or the like. In the present example embodiment, first transport device 151 includes forward conveyor 153 and backward conveyor 154 that are arranged in an up and down direction, and lifting and lowering device 155 that lifts, to first area 201, transfer source box 210 received from forward conveyor 153, lowers, to backward conveyor 154, transfer source box 210 from which the at least one of objects 200 has been transferred, and passes transfer source box 210 to backward conveyor 154.

Second transport device 152 transports, to second area 202, transfer destination box 220 in which the at least one of objects 200 is to be contained. Moreover, second transport device 152 transports transfer destination box 220 out of second area 202 after the at least one of objects 200 has been transported into transfer destination box 220 by at least one of first transfer device 110 or second transfer device 120. The type of second transport device 152 is not particularly limited and is exemplified by, for example, a conveyor, an unmanned transport vehicle, or the like. Second transport device 152 may have the same configuration as that of first transport device 151 or have a configuration different from that of first transport device 151, and may be of a type different from that of first transport device 151. In the present example embodiment, second transport device 152 is configured in the same manner as first transport device 151 and includes a forward conveyor (not illustrated), a backward conveyor (not illustrated) , and a lifting and lowering device (not illustrated).

Rail 130 is a component that guides reciprocating movement of first transfer device 110 and second transfer device 120 over first area 201 and second area 202. In the present example embodiment, rail 130 is disposed on a side of first area 201 and second area 202 (a side to which first transport device 151 and second transport device 152 extend), and extends straight from first area 201 to second area 202. Rail 130 is disposed above first transport device 151 and second transport device 152 in a state in which rail 130 straddles at least one of first transport device 151 or second transport device 152 (in the present example embodiment, straddles both of first transport device 151 and second transport device 152). It should be noted that when each of first transport device 151 and second transport device 152 is a cart, rail 130 may be disposed so that first transport device 151 and second transport device 152 can pass under rail 130.

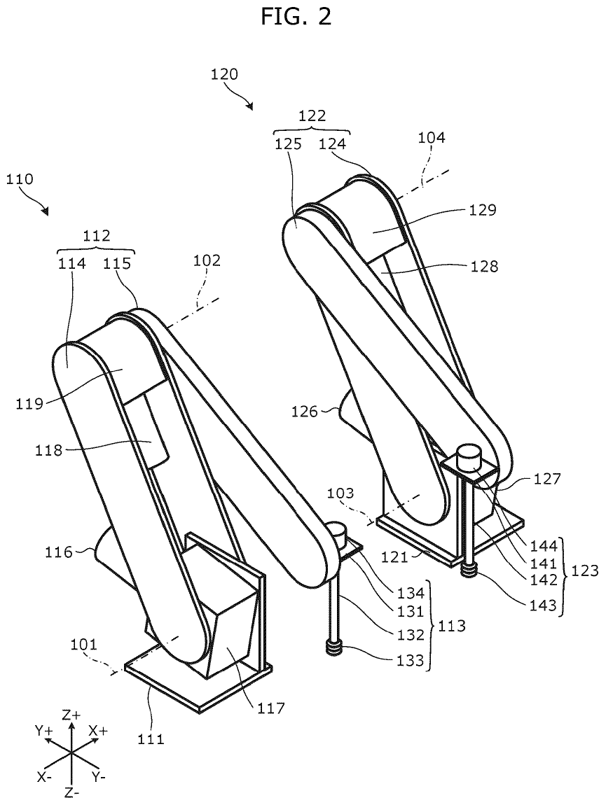

FIG. 2 is a perspective view illustrating first transfer device 110 and second transfer device 120. First transfer device 110 transfers object 200 from first area 201 to second area 202. The type of first transfer device 110 is not particularly limited and can be exemplified by an orthogonal robot, an articulated robot, a parallel link robot, or the like. In the present example embodiment, a perpendicular articulated robot is used as first transfer device 110. First transfer device 110 includes first traveling body 111, first arm 112, and first holder 113.

First traveling body 111 is a basic component of first transfer device 110, and is component that reciprocates in the extending direction of rail 130 (the X-axis direction in the Drawings) while being guided by rail 130. A driving method for causing first traveling body 111 to travel along rail 130 is not particularly limited. In the present example embodiment, first traveling body 111 is linked to a ring-shaped belt (not illustrated) disposed inside rail 130. The ring-shaped belt is rotated by first travel driving source 138 (see FIG. 1) including a motor attached to rail 130 so that first traveling body 111 reciprocates in the extending direction of rail 130 while being guided by rail 130. It should be noted that first traveling body 111 may be driven by a linear motor or may travel based on rotation of a ball screw, a feed screw, or the like.

First arm 112 is a component that includes a distal end portion and a proximal end portion that is attached to first traveling body 111, and moves first holder 113 attached to the distal end portion to an arbitrary position in first area 201 and an arbitrary position in second area 202. In the present example embodiment, first arm 112 includes first upper arm 114 that is attached to first traveling body 111 so that first upper arm 114 can rotate about first rotation axis 101 extending along the extending direction of rail 130 (the X-axis direction in the Drawings), and first forearm 115 that is attached to a side (side facing second transfer device 120) of a distal end portion of first upper arm 114 so that first forearm 115 can rotate about second rotation axis 102 that is parallel to first rotation axis 101.

First upper arm 114 is attached to first traveling body 111 at its proximal end portion so that first upper arm 114 can rotate with respect to first traveling body 111 in a first plane (the YZ plane in the Drawings) that is a prescribed plane intersecting (in the present example embodiment, orthogonal to) the extending direction of rail 130 and cannot move relative to the extending direction. First upper arm 114 is linked to first upper arm driver 117 including first upper arm motor 116, and is driven with respect to first traveling body 111 by a driving force from first upper arm driver 117. Specifically, first upper arm 114 is rotated about first rotation axis 101 with respect to first traveling body 111. First forearm 115 is attached to the distal end portion of first upper arm 114 at its proximal end portion so that first forearm 115 can rotate with respect to first upper arm 114 in a plane parallel to the first plane and cannot move relative to the extending direction. First forearm 115 is linked to first forearm driver 119 including first forearm motor 118, and is driven with respect to first upper arm 114 by a driving force from first forearm driver 119. Specifically, first forearm 115 is rotated about second rotation axis 102 with respect to first upper arm 114.

According to such a configuration, each of first upper arm 114 and first forearm 115 included in first arm 112 moves in a plane parallel to the first plane but does not move in the extending direction of rail 130 in a state in which the position of first traveling body 111 is fixed. Moreover, first holder 113 attached to first arm 112 also moves in a plane parallel to the first plane but does not move in the extending direction of rail 130 in a state in which the position of first traveling body 111 is fixed.

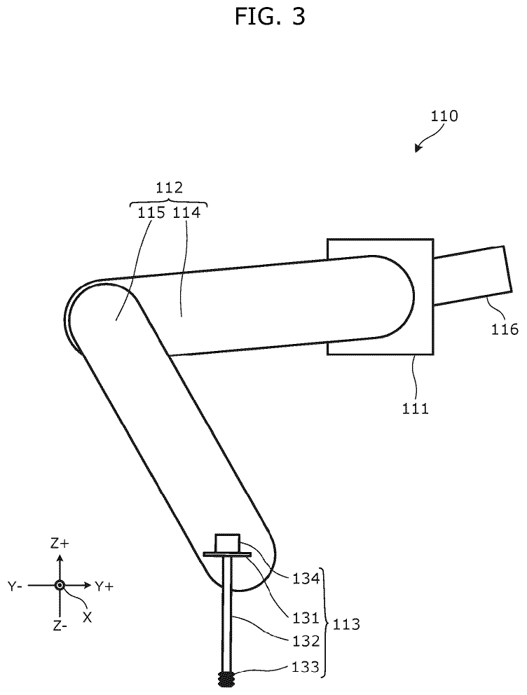

First forearm 115 is attached to a second transfer device 120-side lateral surface of first upper arm 114. First holder 113 is attached to a second transfer device 120-side lateral surface of a distal end portion of first forearm 115 so that first holder 113 protrudes toward second transfer device 120. In other words, first holder 113 is attached on a side opposite to first upper arm 114 with respect to first forearm 115. First upper arm 114, first forearm 115, and first holder 113 are arranged at positions mutually displaced (offset) with respect to the extending direction of rail 130. Thus, even when first forearm 115 rotates with respect to first upper arm 114, first holder 113 does not interfere with first upper arm 114. Accordingly, a range in which first holder 113 is placeable (is movable) can be expanded. For example, as illustrated in FIG. 3, when first transfer device 110 is viewed in the extending direction of rail 130 (the X-axis direction), a posture in which first forearm 115 is located directly below first upper arm 114 and first holder 113 is located in the vicinity of first traveling body 111 with respect to the Y-axis direction (first holder 113 approaches a position close to a place directly below first traveling body 111) becomes possible.

First holder 113 is attached to first arm 112 and disposed at a desired position in first area 201 and second area 202, and can hold object 200 and release object 200 held. First holder 113 is attached to the distal end portion of first forearm 115. In the present example embodiment, first holder 113 includes first hand 131, first rod 132, first holder 133, and first rotator 134.

First hand 131 is a plate-shaped component that is attached to first forearm 115 so that first hand 131 is kept in a fixed angle with respect to first traveling body 111 by a first link mechanism (not illustrated).

First rod 132 is a bar-shaped component that is attached to first hand 131 so as to protrude in a direction perpendicular to first hand 131. When first holder 113 holds object 200 by suction, first rod 132 may be in a tubular shape serving as a suction passage.

First holder 133 is a component that is attached to a distal end portion (lower end portion) of first rod 132 to hold object 200. The type of first holder 133 is not particularly limited and, first holder 133 may be, for example, a chuck that sandwiches and holds object 200. In the present example embodiment, first holder 113 holds object 200 by vacuum suction, and first holder 133 is a suction pad.

First rotator 134 causes first rod 132 to rotate about an axial center with respect to first hand 131, and includes a motor. When first holder 133 is a chuck or the like, first rotator 134 may cause the chuck to rotate according to the posture of object 200. In the present example embodiment, first rotator 134 changes, by rotation, the posture of object 200 held and sucked at a distal end of first holder 133 so that object 200 can be released in a desired posture in second area 202.

Similar to first transfer device 110, second transfer device 120 transfers object 200 from first area 201 to second area 202. The type of second transfer device 120 is not particularly limited and is exemplified by an orthogonal robot, an articulated robot, a parallel link robot, or the like. In the present example embodiment, second transfer device 120 is of the same type as that of first transfer device 110, and a perpendicular articulated robot is used as second transfer device 120. Second transfer device 120 includes second traveling body 121, second arm 122, and second holder 123.

Second traveling body 121 is a basic component of second transfer device 120, and is a component that reciprocates in the extending direction of rail 130 (the X-axis direction in the Drawings) while being guided by rail 130. A driving method for causing second traveling body 121 to travel along rail 130 is not particularly limited. In the present example embodiment, second traveling body 121 is linked to a ring-shaped belt (not illustrated) disposed inside rail 130. The belt linked to second traveling body 121 is separate from the belt linked to first traveling body 111, and the belt linked to second traveling body 121 and the belt linked to first traveling body 111 rotate independently of the other. The ring-shaped belt is rotated by second travel driving source 139 (see FIG. 1) including a motor attached to rail 130 so that second traveling body 121 reciprocates in the extending direction of rail 130 while being guided by rail 130. It should be noted that second traveling body 121 may be driven by a linear motor or may travel based on rotation of a ball screw, a feed screw, or the like.

Second arm 122 is a component that includes a distal end portion and a proximal end portion that is attached to second traveling body 121, and moves second holder 123 attached to the distal end portion to an arbitrary position in first area 201 and an arbitrary position in second area 202. In the present example embodiment, second arm 122 includes second upper arm 124 that is attached to second traveling body 121 so that second upper arm 124 can rotate about third rotation axis 103 extending along the extending direction of rail 130 (the X-axis direction in the Drawings); and second forearm 125 that is attached to a side (side facing first transfer device 110) of a distal end portion of second upper arm 124 so that second forearm 125 can rotate about fourth rotation axis 104 that is parallel to third rotation axis 103.

Second upper arm 124 is attached to second traveling body 121 at its proximal end portion so that second upper arm 124 can rotate with respect to second traveling body 121 in a plane parallel to the first plane and cannot move relative to the extending direction. Second upper arm 124 is linked to second upper arm driver 127 including second upper arm motor 126, and is driven with respect to second traveling body 121 by a driving force from second upper arm driver 127. Specifically, second upper arm 124 is rotated about third rotation axis 103 with respect to second traveling body 121. Second forearm 125 is attached to the distal end portion of second upper arm 124 at its proximal end portion so that second forearm 125 can rotate with respect to second upper arm 124 in a plane parallel to the first plane and cannot move relative to the extending direction. Second forearm 125 is linked to second forearm driver 129 including second forearm motor 128, and is rotated and driven with respect to second upper arm 124 by a driving force from second forearm driver 129. Specifically, second forearm 125 is rotated about fourth rotation axis 104 with respect to second upper arm 124.

According to such a configuration, each of second upper arm 124 and second forearm 125 included in second arm 122 moves in a plane parallel to the first plane. However, each of second upper arm 124 and second forearm 125 does not move in the extending direction of rail 130 in a state in which the position of second traveling body 121 is fixed. Moreover, second holder 123 attached to second arm 122 also moves in a plane parallel to the first plane but does not move in the extending direction of rail 130 in a state in which the position of second traveling body 121 is fixed. It should be noted that the first plane is a virtual plane and the location of the first plane is not particularly limited.

Second forearm 125 is attached to a first transfer device 110-side lateral surface of second upper arm 124. Second holder 123 is attached to a first transfer device 110-side lateral surface of a distal end portion of second forearm 125 so that second holder 123 protrudes toward first transfer device 110. In other words, second holder 123 is attached to a side opposite to second upper arm 124 with respect to second forearm 125. Namely, second upper arm 124, second forearm 125, and second holder 123 are arranged at positions mutually displaced (offset) with respect to the extending direction of rail 130. Thus, even when second forearm 125 rotates with respect to second upper arm 124, second holder 123 does not interfere with second upper arm 124. Accordingly, a range in which second holder 123 is placeable (is movable) can be expanded. For example, similar to first transfer device 110 illustrated in FIG. 3, when second transfer device 120 is viewed in the extending direction of rail 130 (the X-axis direction), a posture in which second forearm 125 is located directly below second upper arm 124 and second holder 123 is located in the vicinity of second traveling body 121 with respect to the Y-axis direction (second holder 123 approaches a position close to a place directly below second traveling body 121) becomes possible.

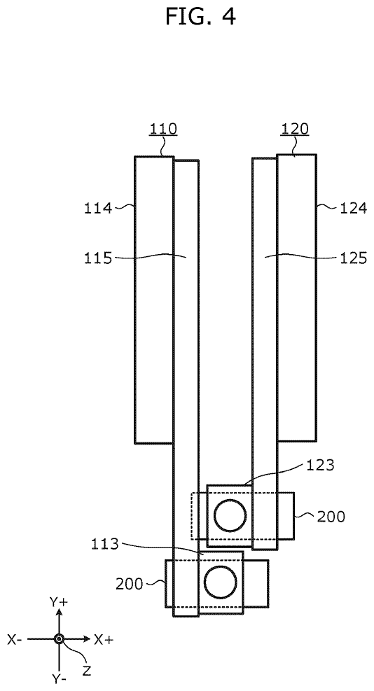

First transfer device 110 and second transfer device 120 have a plane-symmetrical structure with respect to the YZ plane in the Drawings. Accordingly, as illustrated in FIG. 4 described below, first transfer device 110 and second transfer device 120 can be arranged as close as possible to each other while avoiding interference between first holder 113 and second holder 123.

Second holder 123 is attached to second arm 122 and placed at a desired position in first area 201 and second area 202, and can hold object 200 and release object 200 held. Second holder 123 is attached to the distal end portion of second forearm 125. In the present example embodiment, second holder 123 includes second hand 141, second rod 142, second holder 143, and second rotator 144.

Second hand 141 is a plate-shaped component that is attached to second forearm 125 so that second hand 141 is kept in a fixed angle with respect to second traveling body 121 by a second link mechanism (not illustrated).

Second rod 142 is a bar-shaped component that is attached to second hand 141 so as to protrude in a direction perpendicular to second hand 141. When second holder 123 holds object 200 by suction, second rod 142 may have a tubular shape and define and function as a suction passage.

Second holder 143 is a component that is attached to a distal end portion (lower end portion) of second rod 142 to hold object 200. The type of second holder 143 is not particularly limited and, second holder 143 may be, for example, a chuck that sandwiches and holds object 200. In the present example embodiment, second holder 123 holds object 200 by vacuum suction, and second holder 143 is a suction pad.

Second rotator 144 causes second rod 142 to rotate about an axial center with respect to second hand 141, and includes a motor. When second holder 143 is a chuck or the like, second rotator 144 may cause the chuck to rotate according to the posture of object 200. In the present example embodiment, second rotator 144 changes, by rotation, the posture of object 200 held and sucked at a distal end of second holder 143 so that object 200 can be released in a desired posture in second area 202.

FIG. 4 is a plan view for explaining a possible relative positional relationship between first holder 113 included in first transfer device 110 and second holder 123 included in second transfer device 120. As illustrated in FIG. 4, in the plan view, first holder 113 (first holder 133) included in first transfer device 110 protrudes toward second transfer device 120 with respect to first forearm 115. In the plan view, second holder 123 (second holder 143) included in second transfer device 120 protrudes toward first transfer device 110 with respect to second forearm 125.

In picking device 100 configured as above, as illustrated in FIG. 4, since first holder 113 and second holder 123 are arranged at positions mutually displaced (positions not overlapping each other) with respect to a direction (the Y-axis direction in FIG. 4) that is horizontal and perpendicular to the extending direction of rail 130, first holder 113 and second holder 123 can be at least partially located at the same position (positions overlapping each other) with respect to the extending direction of rail 130 (the X-axis direction in FIG. 4). With such a configuration, as illustrated in FIG. 4, first holder 113 and second holder 123 can simultaneously (at the same time) pick up two objects 200 that are at least partially located at the same position with respect to the X-axis direction.

In contrast, such a relative positional relationship cannot be achieved by a configuration in which first holder 113 is provided so as not to protrude toward second transfer device 120 with respect to first forearm 115 (first holder 113 is provided at the same position as first forearm 115 with respect to the X-axis direction or provided so as to protrude toward first transfer device 110) and a configuration in which second holder 123 is provided so as not to protrude toward first transfer device 110 with respect to second forearm 125 (second holder 123 is provided at the same position as second forearm 125 with respect to the X-axis direction or provided so as to protrude toward second transfer device 120). Therefore, first holder 113 and second holder 123 cannot simultaneously (at the same time) pick up two objects 200 that are at least partially located at the same position with respect to the X-axis direction.

With picking device 100 according to the above-described example embodiments, since first transfer device 110 and second transfer device 120 travel while being guided by the same rail 130 to transfer objects 200 from first area 201 to second area 202, objects 200 can be transferred by a distance that is greater than or equal to a distance that can be reached by an arm included in each of first transfer device 110 and second transfer device 120 when the arm is stretched out. Moreover, since first transfer device 110 and second transfer device 120 cooperate to transfer objects 200, transfer efficiency can be improved as compared to a configuration in which a single transfer device transfers object 200.

Furthermore, since rail 130 straddles first transport device 151 and second transport device 152, and first transfer device 110 and second transfer device 120 move in a state in which first transfer device 110 and second transfer device 120 three-dimensionally cross first transport device 151 and second transport device 152, picking device 100 can be made compact as a whole.

Furthermore, since first arm 112 and second arm 122 are configured to cause each of first holder 113 and second holder 123 to move in a plane perpendicular to the extending direction of rail 130 and not to move along the extending direction of rail 130, only a distance between first traveling body 111 and second traveling body 121 in the extending direction of rail 130 needs to be monitored for interference prevention control of first transfer device 110 and second transfer device 120, and picking device 100 is easy to control as compared to a picking device including two transfer devices of which arms interfere with each other.

Furthermore, first holder 113 and second holder 123 protruding in a mutually approaching direction can be arranged side by side in a direction (the Y-axis direction in the Drawings) orthogonal to the extending direction of rail 130 (the X-axis direction in the Drawings) as illustrated in FIG. 4, and first transfer device 110 and second transfer device 120 can simultaneously pick up objects 200 that are adjacent to each other in the extending direction of rail 130 or two objects 200 that are displaced from each other in a direction (the Y-axis direction) orthogonal to the extending direction of rail 130 and are overlapping each other in the extending direction of rail 130 (the X-axis direction). Furthermore, first transfer device 110 and second transfer device 120 can simultaneously release two objects 200 in a state in which two objects 200 are adjacent to each other.

Furthermore, since first upper arm 114 and first holder 113 are arranged so as not to interfere with each other and first forearm 115 can be rotated freely regardless of the posture of first upper arm 114, first holder 113 can also be located directly below first upper arm 114 in a side view. Accordingly, object 200 can be picked up or released also at a position close to and below first transfer device 110. This effect is the same for second transfer device 120.

It should be noted that the scope of the present invention is not limited to the above-described example embodiments. For example, elements, features, characteristics, etc., described in the present Specification may be arbitrarily combined, and/or one or more of the elements, features, characteristics, etc., may be omitted to produce another example embodiment of the present invention. Moreover, various modifications of the above-described example embodiments that may be conceived by those skilled in the art are intended to be included within the spirit and scope of the present invention, as long as they do not depart from the essence of the present invention, that is, the meaning represented by the wording in the claims.

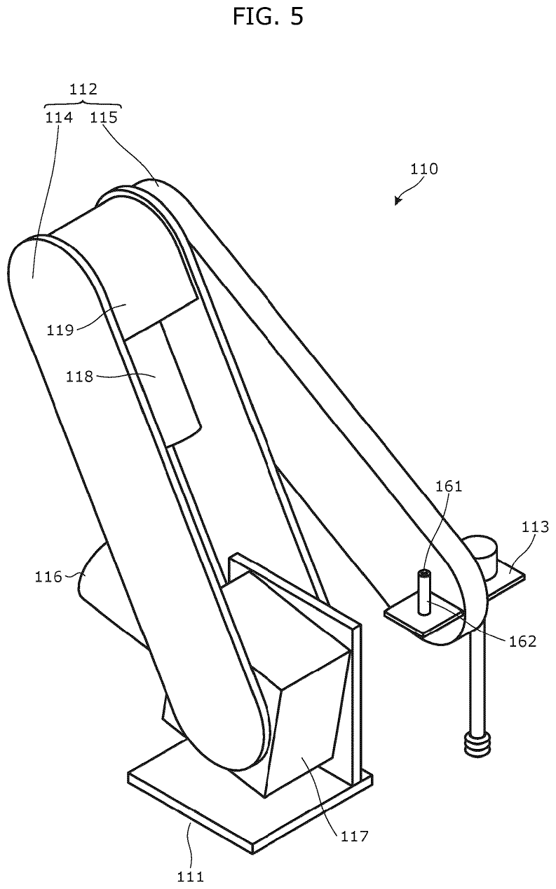

For example, as illustrated in FIG. 5, first transfer device 110 may include holding lever 162 that includes brake releasing switch 161 at its distal end. An operator can arbitrarily rotate first upper arm 114 and first forearm 115 to place first holder 113 at an arbitrary position by pressing brake releasing switch 161 to release electromagnetic brakes included in first upper arm motor 116 and first forearm motor 118 in a state in which the operator holds holding lever 162. Since the electromagnetic brakes can be released in the state in which the operator holds holding lever 162, first arm 112 can be prevented, by releasing the brakes, from being placed at an unintended position. Moreover, when holding lever 162 is attached to the same link mechanism as first holder 113, first arm 112 can be moved while holding lever 162 is kept in the same posture. It should be noted that second transfer device 120 may also include holding lever 162 with brake releasing switch 161.

Moreover, although two transfer devices, that is, first transfer device 110 and second transfer device 120, travel along the same rail 130 to transport objects 200 from first area 201 to second area 202 in picking device 100, three or more transfer devices may travel along the same rail 130 to transport objects 200 from first area 201 to second area 202. Furthermore, each of the number of areas each of which is a transport source of object 200 and the number of areas each of which is a transport destination of object 200 is not limited to one, and a configuration in which objects 200 are transported from first area 201 to second area 202 and a third area that is located at a position different from that of second area 202 in the extending direction of rail 130 and a configuration in which objects 200 are transported, to second area 202, from first area 201 and a fourth area that is located at a position different from that of first area 201 in the extending direction of rail 130 are conceivable.

A first configuration of an example embodiment of the present invention is a picking device including a rail that extends over a first area and a second area in a horizontal direction, a first transfer device to transport an object from the first area to the second area by picking up the object in the first area, traveling along the rail, and then releasing the object in the second area, the first transfer device including a first traveling body that travels while being guided by the rail, a first arm that includes a proximal end portion attached to the first traveling body, and a first holder that is attached to a distal end portion of the first arm to hold an object by suction, and a second transfer device to transport an object from the first area to the second area by picking up the object in the first area, traveling along the rail, and then releasing the object in the second area, the second transfer device including a second traveling body that travels while being guided by the rail, a second arm that includes a proximal end portion attached to the second traveling body, and a second holder that is attached to a distal end portion of the second arm to hold an object by suction, wherein the first arm further includes a first upper arm that includes a proximal end portion attached to the first traveling body to enable rotation of the first upper arm with respect to the first traveling body in a prescribed plane intersecting an extending direction of the rail and prevent motion of the first upper arm relative to the extending direction, and a first forearm that includes a proximal end portion attached to a distal end portion of the first upper arm to enable rotation of the first forearm with respect to the first upper arm in a plane parallel to the prescribed plane and prevent motion of the first forearm relative to the extending direction, the first holder is attached to a distal end portion of the first forearm, the second arm further includes a second upper arm that includes a proximal end portion attached to the second traveling body to enable rotation of the second upper arm with respect to the second traveling body in a plane parallel to the prescribed plane and prevent motion of the second upper arm relative to the extending direction, and a second forearm that includes a proximal end portion attached to a distal end portion of the second upper arm to enable rotation of the second forearm with respect to the second upper arm in a plane parallel to the prescribed plane and prevent motion of the second forearm relative to the extending direction, and the second holder is attached to a distal end portion of the second forearm.

A second configuration of an example embodiment of the present invention includes the first configuration and further includes a first transport device to transport, to the first area, a transfer source box in which one or more objects are contained, and transport the transfer source box out of the first area after at least one of the one or more objects contained in the transfer source box has been transported out of the transfer source box by at least one of the first transfer device or the second transfer device, and a second transport device to transport, to the second area, a transfer destination box in which the at least one of the one or more objects is to be contained, and transport the transfer destination box out of the second area after the at least one of the one or more objects has been transported into the transfer destination box by at least one of the first transfer device or the second transfer device, wherein the rail straddles at least one of the first transport device or the second transport device.

A third configuration of an example embodiment of the present invention includes the first configuration or the second configuration, and is further configured such that the first holder protrudes toward the second transfer device with respect to the first forearm, and the second holder protrudes toward the first transfer device with respect to the second forearm.

A fourth configuration of an example embodiment of the present invention includes the third configuration and is further configured such that the first upper arm, the first forearm, and the first holder are mutually displaceable with respect to the extending direction of the rail to enable the first forearm to be located directly below the first upper arm, and the second upper arm, the second forearm, and the second holder are mutually displaceable with respect to the extending direction to enable the second forearm to be located directly below the second upper arm.

A fifth configuration of an example embodiment of the present invention includes the third configuration or the fourth configuration and is further configured such that the first holder includes a first hand attached to the first forearm and kept in a fixed angle by a first link mechanism, a first rod attached to the first hand, and a first holder attached to a distal end portion of the first rod to hold an object, and the second holder includes a second hand attached to the second forearm and kept in a fixed angle by a second link mechanism, a second rod attached to the second hand, and a second holder attached to a distal end portion of the second rod to hold an object.

A sixth configuration of an example embodiment of the present invention includes any one of the third configuration, the fourth configuration, or the fifth configuration, and is further configured such that the first holder further includes a first rotator to rotate the first rod about an axial center with respect to the first hand, and the second holder further includes a second rotator to rotate the second rod about an axial center with respect to the second hand.

Example embodiments of the present invention are applicable to picking devices to pick up, transfer, and release an object.

While example embodiments of the present invention have been described above, it is to be understood that variations and modifications will be apparent to those skilled in the art without departing from the scope and spirit of the present invention. The scope of the present invention, therefore, is to be determined solely by the following claims.

1-7. (canceled)

8. A picking device comprising:
a rail that extends over a first area and a second area in a horizontal direction;
a first transfer device to transport an object from the first area to the second area by picking up the object in the first area, traveling along the rail, and then releasing the object in the second area, the first transfer device including a first traveling body that travels while being guided by the rail, a first arm that includes a proximal end portion attached to the first traveling body, and a first holder that is attached to a distal end portion of the first arm to hold an object by suction; and
a second transfer device to transport an object from the first area to the second area by picking up the object in the first area, traveling along the rail, and then releasing the object in the second area, the second transfer device including a second traveling body that travels while being guided by the rail, a second arm that includes a proximal end portion attached to the second traveling body, and a second holder that is attached to a distal end portion of the second arm to hold an object by suction, wherein
the first arm further includes:
a first upper arm that includes a proximal end portion attached to the first traveling body to enable rotation of the first upper arm with respect to the first traveling body in a prescribed plane intersecting an extending direction of the rail and prevent motion of the first upper arm relative to the extending direction; and
a first forearm that includes a proximal end portion attached to a distal end portion of the first upper arm to enable rotation of the first forearm with respect to the first upper arm in a plane parallel to the prescribed plane and prevent motion of the first forearm relative to the extending direction;
the first holder is attached to a distal end portion of the first forearm;
the second arm further includes:
a second upper arm that includes a proximal end portion attached to the second traveling body to enable rotation of the second upper arm with respect to the second traveling body in a plane parallel to the prescribed plane and prevent motion of the second upper arm relative to the extending direction; and
a second forearm that includes a proximal end portion attached to a distal end portion of the second upper arm to enable rotation of the second forearm with respect to the second upper arm in a plane parallel to the prescribed plane and prevent motion of the second forearm relative to the extending direction; and
the second holder is attached to a distal end portion of the second forearm.

9. The picking device according to claim 8, further comprising:
a first transport device to transport, to the first area, a transfer source box in which one or more objects are contained, and transport the transfer source box out of the first area after at least one of the one or more objects contained in the transfer source box has been transported out of the transfer source box by at least one of the first transfer device or the second transfer device; and
a second transport device to transport, to the second area, a transfer destination box in which the at least one of the one or more objects is to be contained, and transport the transfer destination box out of the second area after the at least one of the one or more objects has been transported into the transfer destination box by at least one of the first transfer device or the second transfer device; wherein
the rail straddles at least one of the first transport device or the second transport device.

10. The picking device according to claim 8, wherein
the first holder protrudes toward the second transfer device with respect to the first forearm; and
the second holder protrudes toward the first transfer device with respect to the second forearm.

11. The picking device according to claim 8, wherein
the first upper arm, the first forearm, and the first holder are mutually displaceable with respect to the extending direction of the rail to enable the first forearm to be located directly below the first upper arm; and
the second upper arm, the second forearm, and the second holder are mutually displaceable with respect to the extending direction to enable the second forearm to be located directly below the second upper arm.

12. The picking device according to claim 8, wherein
the first holder includes:
a first hand attached to the first forearm and kept in a fixed angle by a first link mechanism;
a first rod attached to the first hand; and
a first holder attached to a distal end portion of the first rod to hold an object; and
the second holder includes:
a second hand attached to the second forearm and kept in a fixed angle by a second link mechanism;
a second rod attached to the second hand; and
a second holder attached to a distal end portion of the second rod to hold an object.

13. The picking device according to claim 12, wherein
the first holder further includes a first rotator to rotate the first rod about an axial center with respect to the first hand; and
the second holder further includes a second rotator to rotate the second rod about an axial center with respect to the second hand.
